(19) United States
(12) Patent Application Publication
(10) Pub. No.: US 2025/0285062 A1
(43) Pub. Date: Sep. 11, 2025

(54) GENERATING ENTITY CONTRIBUTION SCORES USING CONFIGURATION INSTRUMENTATION METRICS

(71) Applicant: Wells Fargo Bank, N.A., San Francisco, CA (US)

(72) Inventors: Huanchee Aaron Chan, Fort Mill, SC (US); Jeffrey Dean, Bend, OR (US)

(21) Appl. No.: 18/055,141

(22) Filed: Nov. 14, 2022

(51) Int. Cl. G06Q 10/0639; G06Q 10/0637

(52) U.S. Cl. CPC G06Q 10/06393; G06Q 10/06375

(57) ABSTRACT

Systems, apparatuses, methods, and computer program products are disclosed for generating an entity contribution score for an entity. An example method includes receiving, by a communications hardware, a set of entity configuration evaluation data and identifying, by a configuration identification circuitry, one or more configuration instruments and one or more corresponding configuration instrument metrics. The example method further includes determining, by an entity contribution scoring circuitry, an entity contribution score and generating, by the entity contribution scoring circuitry an entity contribution score report based on the entity contribution score.

### BACKGROUND

Various embodiments of the present invention relate to systems for determining entity scores for entities. Determining entity scores using existing approaches is computationally expensive because most entities have large corpuses of entity contribution data. In response, various embodiments relate to systems that enable determining entity scores for entities using configuration instrumentation metrics for configuration instruments associated with those entities.

### BRIEF SUMMARY

In general, embodiments of the present invention provided herein provide a method to evaluate entity impact by generating entity contribution scores using configuration instrumentation metrics. An entity contribution score may be indicative of the impact the particular entity has on one or more external conditions, such as an impact on the global environmental.

The initial entity contribution score includes sub-entity (e.g., departments, employees, etc.) scores and recommendations for products to improve the initial entity contribution score. Other implementations for entity contribution scores and recommendations will be, or will become, apparent to a person of ordinary skill in the relevant technology upon examination of the following figures and detailed description. It is intended that all such additional implementations be included within this description be within the scope of the disclosure and be protected by the following claims.

In some embodiments, entities may wish to improve their entity contribution score. However, entities may lack access to data necessary to determine their entity contribution score due to their respective operations. For example, entities may not have access to scores or other quantification metrics (e.g., data) useable to compare how different types of operations may increase or decrease their own entity contribution score due to their operations. Consequently, entities may be deprived of the ability to ascertain their own entity contribution score.

Like the lack of access to data, entities may also be limited to accessing general overall entity contribution scores (e.g., entity contribution scores provided by other scoring agencies or other organizations) depriving them of granular insight into how various activities of the entities may impact the overall entity contribution scores. Without having access to granular insights, entities may not be able to identify which activities may have larger or smaller impacts on the entities overall entity contribution scores. Consequently, entities may not be able to take effective action (e.g., make targeted changes) to improve or otherwise manage their overall entity contribution scores.

Additionally, even when entities, and particularly small entities, have access to the necessary data to ascertain their entity contribution score, small entities may not be able to determine how to modify their activities to improve their entity contribution score. For example, if an entity has a poor entity contribution score due to use of paper checks in its operations, the small entity may need to be provided with alternatives to the use of papers checks to drive productive decision making. Without access to the alternatives, the entity may elect to not make any changes to its practices because no compelling alternatives to its present activities are known to it.

Systems and methods herein solve the above technical challenges by generating an entity contribution score for an entity by identifying configuration instruments from entity configuration evaluation data and automatically determining an entity contribution score based on the one or more configuration instruments and configuration instrument metrics. An entity contribution score report may be generated, which may indicate the generated contribution score report for the entity and may be provided to one or more computing devices. As such, this may empower entities to manage its operations impacting its entity contribution score by ascertaining its current entity contribution score, identifying key activities that contribute to the current entity contribution score, and subsequently identifying and implementing alternative activities that may allow the entity to manage its entity contribution score while maintaining its everyday operations.

To identify whether to adopt alternative configuration instruments, an entity may also specify a dynamic threshold. The dynamic threshold may define a short term, incremental goal with respect to the level of entity contribution impact that an entity will strive to achieve as part of a larger goal of achieving a particular entity contribution score. The dynamic threshold may be used by an entity to identify a number and/or type of alternative operations that may need to be adopted during the short-term time period to be on track to meet the larger goal. For example, an entity may use the dynamic threshold to identify when a sufficient quantity of alternative operations have been selected for adoption so that the larger goal will be met (e.g., through incremental changes made during multiple, short-term time periods).

In one example embodiment, a method is provided for generating an entity contribution score for an entity. The method further includes receiving, by a communications hardware, a set of entity configuration evaluation data which is associated with the entity and identifying, by a configuration identification circuitry, one or more configuration instruments from a plurality of candidate configuration instruments and one or more corresponding configuration instrument metrics based on the set of entity configuration evaluation data. The method further includes determining, by an entity contribution scoring circuitry, an entity contribution score for the entity based on each identified configuration instrument and the one or more corresponding configuration instrument metrics and generating, by the entity contribution scoring circuitry, an entity contribution score report based on the entity contribution score, wherein the entity contribution score report is indicative of the entity contribution score for the entity.

In another example embodiment, an apparatus is provided for generating an entity contribution score for an entity. The apparatus includes communications hardware configured to receive a set of entity configuration evaluation data which is associated with the entity. The apparatus further includes configuration identification circuitry configured to identify one or more configuration instruments from a plurality of candidate configuration instruments and one or more corresponding configuration instrument metrics based on the set of entity configuration evaluation data. The apparatus further includes entity contribution scoring circuitry configured to determine an entity contribution score for the entity based on each identified configuration instrument and the one or more corresponding configuration instrument metrics and generate an entity contribution score report based on the entity contribution score, wherein the entity contribution score report is indicative of the entity contribution score for the entity.

In another example embodiment, a computer program product is provided for generating an entity contribution score for an entity. The computer program product includes at least one non-transitory computer-readable storage medium storing software instructions that, when executed, cause an apparatus to receive a set of entity configuration evaluation data which is associated with the entity and identify one or more configuration instruments from a plurality of candidate configuration instruments and one or more corresponding configuration instrument metrics based on the set of entity configuration evaluation data. The at least one non-transitory computer-readable storage medium storing the software instructions that, when executed, further cause an apparatus to determine an entity contribution score for the entity based on each identified configuration instrument and the one or more corresponding configuration instrument metrics and generate an entity contribution score report based on the entity contribution score, wherein the entity contribution score report is indicative of the entity contribution score for the entity.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a device that may perform various operations in accordance with some example embodiments described herein.

FIG. 3 illustrates an example flowchart for generating an entity contribution score report, in accordance with some example embodiments described herein.

FIG. 4 illustrates an example flowchart for either generating alternative configuration instruments or displaying a message indicating the confirmation instrument score threshold has been met, in accordance with some example embodiments described herein.

FIG. 5 illustrates an example flowchart for determining a sub-entity contribution score, in accordance with some example embodiments described herein.

FIG. 6 illustrates an example of an entity contribution report, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” may refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “storage devices” may refer to any electronic device capable of storing data. For example, a data storage repository or data warehouse are considered storage devices.

The word “example” is used to mean “serving as an example, instance, or illustration”. Any implementation described herein as “example” is not necessarily to be construed as preferred or advantageous over other implementations.

The terms “data”, may be used interchangeably to refer to data capable of being transmitted, received, and/or stored in accordance with embodiments of the present invention. Thus, use the term “data” should not be taken to limit the spirit or scope of embodiments of the present invention. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

The term “entity contribution score” may refer to a data construct that describes a computed score for an entity based on configuration instrument metrics associated with one or more configuration instruments of the user. In some embodiments, the entity contribution score for an entity is a numerical score that is determined based on the entities' environmental, social, and governance impact. For example, an entity heavily emitting greenhouse gases may have a low entity contribution score. In some embodiments, the entity contribution score for an entity is determined in accordance with a set of Environmental, Social, and Governance (ESG) standards that may be used to evaluate an entity's impact on society. To quantify the impact on society, ESG scores may be calculated based on the manner in which the entities operate. The ESG scores may be non-financial metrics that have become an increasingly valuable indicator amongst investors interested in investing in companies with higher long-term potential.

The term “per-entity contribution score” may refer to a data construct detailing the impact a sub-entity has on an entity contribution score. In some embodiments, the per-entity contribution score is a numerical score that is determined based on the per-configuration instruments scores within the sub-entity. For example, a finance department utilizing paper billing within a large entity may receive a poor per-entity contribution score. The per-entity contribution score may be weighted to account for the impact the sub-entity has towards the overall entity contribution score.

The term “per-configuration instrument score” may refer to a data construct describing the impact a configuration instrument has on an entity contribution score. In some embodiments, the per-configuration instrument score is a numerical score that is determined based on the configuration instrument metrics for the respective configuration instrument (impact score). For example, a configuration instrument depositing toxic waste may receive a per configuration instrument score reflective of its negative environmental impact. The per-configuration instrument score may be weighted to account for the impact the configuration instrument has towards the larger per-entity contribution score or entity contribution score.

The term “entity” may refer to a data construct that describes a system with respect to which an entity contribution score is being generated based on the configuration instruments associated with the entity. For example, an individual department of a large business interested in obtaining an entity contribution score may be referred to as an entity. Additionally, a large entity including many departments, may be interested in an entity contribution score that encompasses the entirety of the company. In some embodiments, to generate the entity contribution score, one or more configuration instruments associated with the entity are identified based on the entity configuration evaluation data for the entity. In some of the noted embodiments, once the configuration instruments for the entity are identified, then configuration instrument metrics for the identified configuration instruments can be used to generate the entity contribution score for the entity.

The term “sub-entity” refers to a data construct that describes a component of an entity. For example, a large entity consisting of many departments may be interested in identifying their current entity contribution score. Identifying each of the departments as an individual sub-entity may provide the entity with granular insight as to which department has the greatest entity contribution score.

The term “entity configuration evaluation data” refers to a data construct that describes input data associated with a corresponding entity that can be used to determine the entity contribution score for the entity. In some embodiments, the entity contribution evaluation data is the aggregation of all financial statements and business records that may be used to calculate the entity's contribution score. For example, a financial statement detailing the utility payments for an office space may be considered entity configuration evaluation data. In some embodiments, the entity configuration evaluation data includes data retrieved from one or more databases associated with the entity. In some embodiments, to determine the entity configuration evaluation data for an entity, a set of high-level filtering operations are performed on data retrieved from one or more databases of the entity to generate the entity configuration evaluation data. In some of the noted embodiments, once the entity configuration evaluation data are generated using the set of high-level filtering operations, a set of low-level filtering operations are performed to extract data identifying configuration instruments of the entity from the entity configuration evaluation data.

The term “configuration instrument” may refer to a data construct that is configured to describe a particular type of product or activity used by an entity and/or accessible to an entity. Each configuration instrument may be associated with an impact score, which may be indicative of the level of impact the particular configuration instrument on external conditions. Additionally, each configuration instrument may correspond to a configuration instrument type which may be indicative of a use category to which the configuration instrument belongs.

### System Architecture

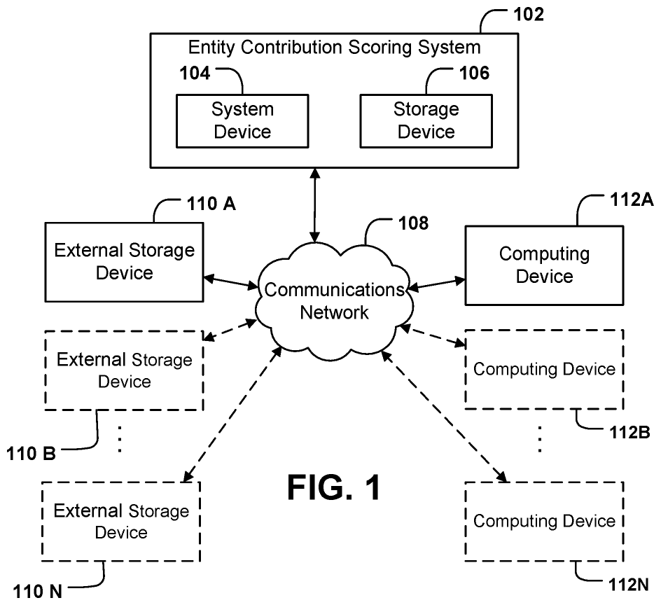

Example embodiments described herein may be implemented using any of a variety of computing devices or servers. To this end, FIG. 1 illustrates an example environment within which various embodiments may operate. As illustrated, an entity contribution scoring system 102 may include a system device 104 in communication with a storage device 106. Although system device 104 and storage device 106 are described in singular form, some embodiments may utilize more than one system device 104 and/or more than one storage device 106.

Additionally, some embodiments of the entity contribution scoring system 102 may not require a storage device 106 at all. Whatever the implementation, the entity contribution scoring system 102, and its constituent system device(s) 104 and/or storage device(s) 106 may receive and/or transmit information via communications network 108 (e.g., the Internet) with any number of other devices, such as one or more of external storage devices 110A-110N and/or computing devices 112A-112N.

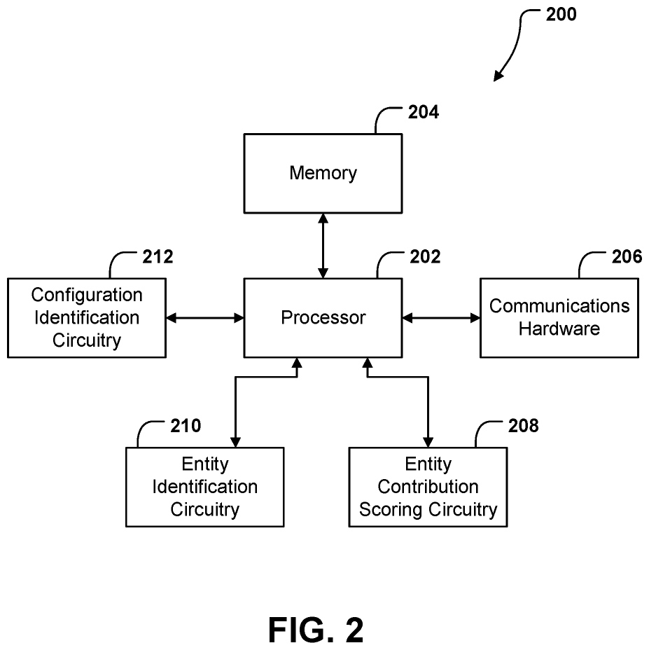

System device 104 may be implemented as one or more servers, which may or may not be physically proximate to other components of entity contribution scoring system 102. Furthermore, some components of system device 104 may be physically proximate to the other components of entity contribution scoring system 102 while other components are not. System device 104 may receive, process, generate, and transmit data, signals, and electronic information to facilitate the operations of the entity contribution scoring system 102. Particular components of system device 104 are described in greater detail below with reference to apparatus 200 in connection with FIG. 2.

Storage device 106 may comprise a distinct component from system device 104 may comprise an element of system device 104 (e.g., memory 204, as described below in connection with FIG. 2). Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the entity contribution scoring system 102. Storage device 106 may store information relied upon during operation of the entity contribution scoring system 102, such as various algorithms that may be used by the entity contribution scoring system 102, data and documents to be analyzed using the entity contribution scoring system 102, and/or the like. In addition, storage device 106 may store control signals, device characteristics, and access credentials enabling interaction between the entity contribution scoring system 102 and one or more of the external storage devices 110A-110N or computing devices 112A-112N.

The one or more external storage devices 110A-110N may be embodied by any storage devices known in the art. Similarly, the one or more computing devices 112A-112N may be embodied by any computing devices known in the art, such as desktop or laptop computers, tablet devices, smartphones, or the like. The one or more computing devices 112A-112N and the one or more storage device 110A-110N need not themselves be independent devices, but may be peripheral devices communicatively coupled to other computing devices.

Although FIG. 1 illustrates an environment and implementation in which the entity contribution scoring system 102 interacts with one or more of external storage devices 110A-110N and/or one or more computing devices 112A-112N. In some embodiments, users may directly interact with the entity contribution scoring system 102 (e.g., via input/output circuitry of system device 104). Whether by way of direct interaction or via a separate computing device, a user may communicate with, operate, control, modify, or otherwise interact with the entity contribution scoring system 102 to perform the various functions and achieve the various benefits described herein.

### Example Implementing Apparatuses

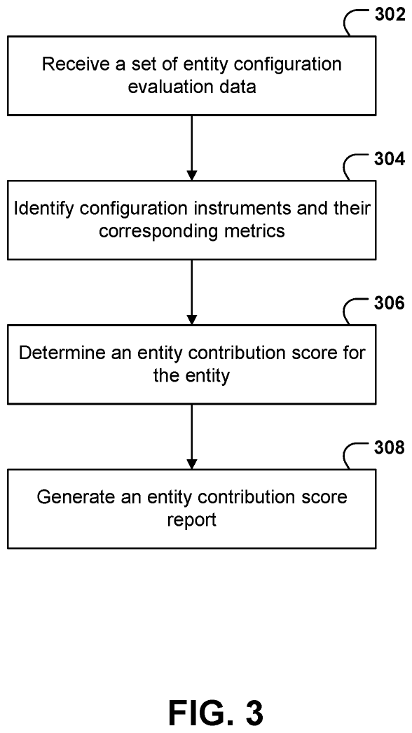

System device 104 of the entity contribution scoring system 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, entity contribution scoring circuitry 208, entity identification circuitry 210, and/or configuration identification circuitry 212, each of which will be described in greater detail below. While the various components are only illustrated in FIG. 2 as being connected with processor 202, it will be understood that the apparatus 200 may further comprises a bus (not expressly shown in FIG. 2) for passing information amongst any combination of the various components of the apparatus 200. The apparatus 200 may be configured to execute various operations described above in connection with FIG. 1 and below in connection with FIGS. 3-5.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 may further comprise an entity contribution scoring circuitry 208 that may determine the entity contribution score and/or sub-entity contribution scores for the entity and generate an entity contribution score report based on the entity contribution score and/or sub-entity contribution scores. The entity contribution scoring circuitry 208 may utilize processor 202, memory 204, or any other hardware component included in the apparatus 200 to perform these operations, as described in connection with FIGS. 3-5 below. The entity contribution scoring circuitry 208 may further utilize communications hardware 206 to gather data from a variety of sources (e.g., external storage device 110A-110N or storage device 106, as shown in FIG. 1), and/or exchange data with a user. The entity contribution scoring circuitry may utilize processor 202 and/or memory 204 to determine one or more alternative configuration instruments and their respective impact scores to be presented to the entity.

In addition, the apparatus 200 further comprises an entity identification circuitry 210 that identifies the sub-entities associated within an entity. The entity identification circuitry 210 may utilize processor 202, memory 204, or any other hardware component included in the apparatus 200 to perform these operations, as described in connection with FIGS. 3-5 below. The entity identification circuitry 210 may further utilize communications hardware 206 to gather data from a variety of sources (e.g., external storage device 110A-110N or storage device 106, as shown in FIG. 1), and/or exchange data with a user, and in some embodiments may utilize processor 202 and/or memory 204 to identify sub-entities for comparison across the industry dataset.

In addition, the apparatus 200 further comprises a configuration identification circuitry 212 that identifies one or more configuration instruments from a plurality of candidate configuration instruments. Further, configuration identification circuitry 212 may also identify alternative configuration instruments from a plurality of alternative instruments. In particular the plurality of candidate configuration instruments and plurality of alternative instruments may be formatted (e.g., as a table, list, vector, array, and/or the like) and stored in memory 204. The configuration identification circuitry 212 may be configured to access memory 204 to identify the plurality of candidate configuration instruments and/or plurality of alternative instruments. The configuration identification circuitry 212 may utilize processor 202, memory 204, or any other hardware component included in the apparatus 200 to perform these operations, as described in connection with FIGS. 3-5 below. The configuration identification circuitry 212 may further utilize communications hardware 206 to gather data from a variety of sources (e.g., external storage device 110A-110N or storage device 106, as shown in FIG. 1), and/or exchange data with a user, and in some embodiments may utilize processor 202 and/or memory 204 to obtain configuration instrument metrics (e.g., the number of checks an entity uses).

Although components 202-212 are described in part using functional language, it will be understood that the particular implementations necessarily include the use of particular hardware. It should also be understood that certain of these components 202-212 may include similar or common hardware. For example, the entity contribution scoring circuitry 208, entity identification circuitry 210, and configuration identification circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry,” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the entity contribution scoring circuitry 208, entity identification circuitry 210, and configuration identification circuitry 212 may leverage processor 202, memory 204, or communications hardware 206 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, or communications hardware 206 for enabling any functions not performed by special-purpose hardware elements. In all embodiments, however, it will be understood that the entity contribution scoring circuitry 208, entity identification circuitry 210, and configuration identification circuitry 212 are implemented via particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of example operations flow charts.

### Example Operations

FIGS. 3-5 illustrate example flowcharts that contain example operations implemented by embodiments described herein. The example operations illustrated in FIGS. 3-5 may, for example, be performed by system device 104 of the entity contribution scoring system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, entity contribution scoring circuitry 208, entity identification circuitry 210, configuration identification circuitry 212, and/or any combination thereof. It will be understood that user interaction with the entity contribution scoring system 102 may occur directly via communications hardware 206, or may instead be facilitated by a separate computing device 112, as shown in FIG. 1, and which may have similar or equivalent physical componentry facilitating such user interaction.

Turning first to FIG. 3, example operations are shown for a method for generating an entity contribution score for an entity. As shown by operation 302, the apparatus 200 includes means, such as processor 202, memory 204, communications hardware 206, configuration identification circuitry 212, and/or the like, for receiving a set of entity configuration evaluation data which is associated with the entity. In some embodiments, the set of entity configuration evaluation data may include a plurality of entity configuration evaluation data. The entity configuration evaluation data may include any data relating the entity, such as electronic documents, financial statements, and/or business records. For example, entity configuration evaluation data may include a financial statement detailing the utility payments for an office space and relevant attribute data regarding the utility payments (e.g., check number, electronic receipt number, date of payment, associated financial account information, etc.).

In some embodiments, the apparatus 200 may receive a request for an entity contribution score. The request for an entity contribution score may be received from a user such as via a computing device 112A, and/or may be received in response to a periodic or semi-periodic trigger (e.g., automatically generate a request for an entity contribution score every week). The request for an entity contribution score for an entity may contains the set of configuration evaluation data for the entity. Alternatively, the request for an entity contribution score may include only an entity identifier which uniquely identifies the entity from one or more other entities and the apparatus 200 may automatically determine the set of entity configuration evaluation data. In particular, apparatus 200 may determine entity configuration evaluation data by retrieving data from one or more databases associated with the entity, such as the one or more external storage devices 110A-110N. Alternatively, the apparatus 200 may access previously stored data associated with the entity, such as from storage device 106.

In some embodiments, the configuration identification circuitry 212 performs one or more data preparation operations on the data retrieved from one or more databases of the entity to generate the entity configuration evaluation data. Data preparation operations may include deduplication of data, filtering of irrelevant data, handling of missing data (e.g., deletion of missing entries), or other data cleaning operations.

In some embodiments, configuration identification circuitry 212 may identify a portion of the entity configuration evaluation data as indeterminate. For example, a collection of financial statements detailing the annual utility bills for an entity may have a month missing in the record and therefore identified as indeterminate by configuration identification circuitry 212. Communications hardware 206 may provide a complete information request to one or more computing devices associated with the entity, such as one or more computing devices 112A-112N requesting the missing portion of the record from the entity before proceeding with the following operations.

As shown by operation 304, the apparatus 200 includes means, such as processor 202, memory 204, communications hardware 206, entity identification circuitry 210, configuration identification circuitry 212, or the like, for identifying one or more configuration instruments and one or more corresponding configuration instrument metrics for the entity. The one or more configuration instruments may correspond to a plurality of candidate configuration instruments, which may be stored in an associated memory, such as memory 204. Each configuration instrument may describe a particular type of product or activity used by an entity and/or accessible to an entity. For example, a configuration instrument may correspond to a paper check product which can be used by the entity, such as to pay employees, vendors, contractors, and/or the like. As another example, a configuration instrument may correspond to paper marketing materials, which may be used by the entity to showcase existing and/or upcoming offered products and/or services.

The configuration identification circuitry 212 may use the set of configuration evaluation data to identify the one or more configuration instruments. The configuration identification circuitry may use any suitable techniques to process the set of configuration evaluation data, such as optical character recognition (OCR), natural language processing (NLP) techniques, searching algorithms, machine learning models (e.g., convolutional neural networks, recurrent neural networks, etc), and/or the like. For example, the configuration identification circuitry may OCR any data in the set of configuration evaluation data, if needed, and then search for an indicator of a configuration instrument. An indicator may be any identifying feature of a particular configuration instrument. For example, the configuration identification circuitry 212 may search for a banking and routing number, which may act as an identifier, to identify a paper check product configuration instrument. In some embodiments, each candidate configuration instrument is associated with one or more possible indicators such that the configuration instrument corresponding to the particular candidate configuration instrument is identified if one or more of the associated possible indicators are identified.

In some embodiments, each identified configuration instrument may be associated with one or more attributes which describe details regarding the configuration instrument. For example, if a paper check product configuration instrument is identified, then one or more attributes such as the date the paper check was written and/or deposited, the amount the paper check was written for, the recipient of the paper check, a memo written on the check, the authorizer of the check, and/or the like may be identified as attributes.

Each configuration instrument may be associated with a particular configuration instrument type, which may describe a use category to which the configuration instrument belongs. By way of continuing example, a paper check product configuration instrument may correspond to a financial payment configuration instrument category whereas a paper marking material configuration instrument may correspond to a marketing material configuration instrument category.

Each configuration instrument may be associated with an impact score, which may be indicative of the level of impact the particular configuration instrument on external conditions. The impact score may be a numerical value that corresponds to a particular impact score range. For example, an impact score range may be numerical values from −1 to 1, where −1 indicates the most negative impact score and 1 indicates the most positive impact score. The impact score for a particular configuration instrument thus indicates the magnitude of how positive or negative the impact of the particular instrument is. Additionally, the impact score range may be common amongst all candidate configuration instruments such these configuration instruments may be compared with one another. For example, a paper check product configuration instrument may have an impact score of −0.5 whereas an electronic check product configuration instrument may have an impact score of 0.7. As such, it can be determined that the impact score of the electronic check product configuration instrument has a more positive impact than the paper check product configuration instrument.

Additionally, the configuration identification circuitry may identify one or more configuration instrument metrics for each identified configuration instrument. In some embodiments, configuration metrics may describe the extent of use of a particular configuration instrument by the entity. For example, configuration metrics may describe a total number of times a configuration instrument was used over a time window (e.g., over one week, one month, one year, etc.), a frequency of use of the configuration instrument (e.g., daily, weekly, monthly, etc.), a percentage of use of the configuration instrument overall compared to other configuration instruments, etc. In some embodiments, configuration instrument metrics may be identified for each configuration instrument by aggregating all identified configuration instruments of the same configuration instrument category. For example, if ten paper check product configuration instruments are identified, a total of 12 paper check product configuration instruments may be determined for the entity over the given time period, such as over one year. Additionally, the one or more attributes for each paper check product configuration instrument may be used to determine that a check is written once a month to a utility company.

As shown by operation 306, the apparatus 200 includes means, such as processor 202, memory 204, communications hardware 206, entity contribution scoring circuitry 208, entity identification circuitry 210, configuration identification circuitry 212, or the like, for determining an entity contribution score for the entity. At operation 306, the entity contribution scoring circuitry 208 and entity identification circuitry 210 determine an entity contribution score for the entity. An entity contribution score for the entity may be determined based on each identified configuration instrument and the one or more corresponding configuration instrument metrics.

In some embodiments, the entity contribution score for the entity may be performed by determining a per-configuration instrument score for each identified configuration instrument. A per-configuration instrument score may be determined based on the one or more corresponding configuration instrument metrics for the respective configuration instrument. The entity contribution score may then be determined based on each per-configuration instrument score for the identified configuration instruments.

In some embodiments, the entity contribution scoring circuitry may determine the entity contribution score and/or per-configuration instrument score by performing one or more mathematical and/or logical operations on the one or more configuration instrument metrics. In some embodiments, the impact score of the configuration instrument may also be used to determine the entity contribution score. In particular, the entity contribution scoring circuitry may determine the per-configuration instrument score by multiplying the impact score of the configuration instrument with the total number of times the configuration instrument was used over a given time period for each identified configuration instrument. For example, an entity may be identified as having 10 paper check product configuration instruments where a paper check product impact score is −0.5, and 5 electronic check product configuration instruments where an electronic check product impact score is 0.7. The entity contribution scoring circuitry may determine the per-configuration instrument score for the paper check product configuration instrument to be −5 and the electronic check product configuration instrument to be 3.5 using the product of the impact score and the number of configuration instruments for the entity. The entity scoring circuitry may then determine an entity contribution score of −1.5 by summing each per-configuration instrument score.

In some embodiments, the entity contributions scoring circuitry may determine the entity contribution score using an entity contribution machine learning model. The entity contribution machine learning model may be configured to process each identified configuration instrument and the one or more configuration instrument metrics to generate an entity contribution score. In some embodiments, the entity contribution machine learning model is a machine learning model which is a trained logistic regression model. The entity contribution machine learning model may be trained to predict parameters (e.g., weights) for each configuration instrument such that the product of each entity contribution metric (e.g., number of times the configuration instrument was used over a given time window) and the impact score is further weighted according to the entity contribution machine learning model parameters. The entity contribution machine learning model may be trained and periodically retrained using a training data set. The training data set may include labelled data which is indicative of updated and real-time estimated impacts of certain contribution instruments. As such, the entity contribution score may be made more accurate by use of the entity contribution machine learning model.

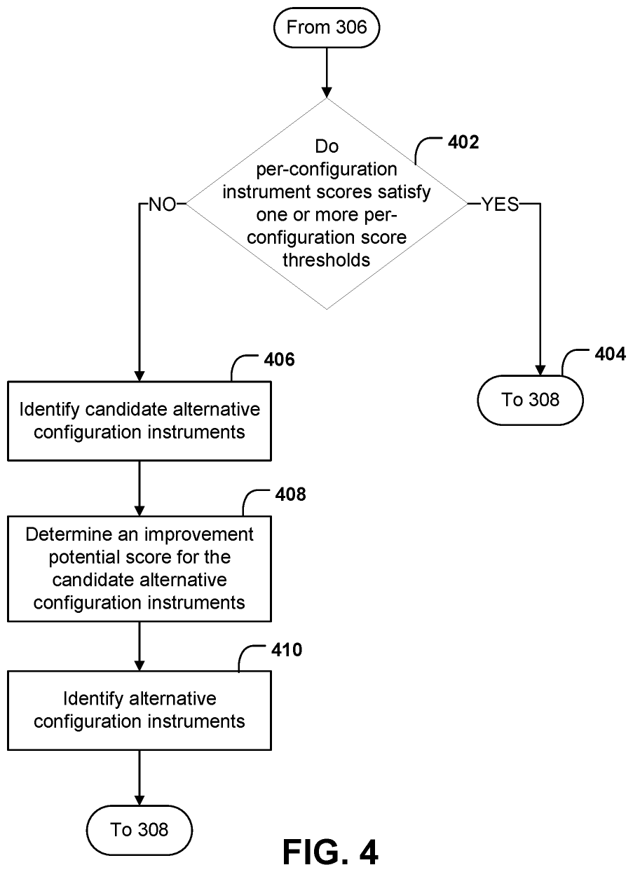

In some embodiments, operation 306 may be performed in accordance with the operations described in FIG. 4. FIG. 4 illustrates example operations for identifying and recommending alternative configuration instruments for the entity.

As shown by operation 402, the apparatus 200 includes means, such as processor 202, memory 204, communications hardware 206, entity contribution scoring circuitry 208, configuration identification circuitry 212, or the like, for determining whether each per-configuration instrument score satisfies one or more per-configuration score thresholds. As described above, the entity contribution scoring circuitry may determine a per-configuration instrument score for each configuration instrument. In some embodiments, these per-configuration instrument scores may be compared to one or more per-configuration score thresholds, which may be set for a particular configuration instrument type and/or configuration instrument. For example, a per-configuration score threshold of −3 may be set for a paper check product or a financial payment configuration instrument type. By way of continuing example, if a paper check product configuration instrument has a per-configuration instrument score of −5, the paper check product configuration instrument may fail to satisfy the per-configuration score threshold for the financial payment configuration instrument type.

In an instance the per-configuration instrument scores satisfy the one or more per-configuration instrument score thresholds, the process may proceed to operation 308.

In an instance a per-configuration instrument score fails to satisfy one or more per-configuration instrument score thresholds, the process may proceed to operation 406. As shown by operation 406, the apparatus 200 includes means, such as processor 202, memory 204, communications hardware 206, entity identification circuitry 210, configuration identification circuitry 212, or the like, for identifying candidate alternative configuration instruments. As mentioned above, each configuration instrument may correspond to a configuration instrument type. A configuration instrument type may be associated with one or more candidate configuration instruments. For example, within the financial payment configuration instrument type, candidate configuration instruments may include a paper check product configuration instrument, an automated clearing house (ACH) debit configuration instrument, and an electronic check product configuration instrument. Each of these configuration instruments included in the financial payment configuration instrument type may be alternative ways to pay for a service or product using a particular financial account. As such, each of these configuration instruments may be used to cause the same result, but may each be associated with a different impact score.

As shown by operation 408, the apparatus 200 includes means, such as processor 202, memory 204, communications hardware 206, entity contribution scoring circuitry 208, or the like, for determining an improvement potential score for each candidate alternative configuration instrument. Once candidate alternative configuration instruments are identified, the entity contribution scoring circuitry may determine whether a candidate alternative configuration instrument results in an improved per-configuration entity score and entity contribution score. The entity contribution scoring circuitry 208 may determine an improvement potential score based on the per-configuration instrument score for the respective identified configuration instrument and a per-alternative configuration instrument score for a respective candidate alternative configuration instrument. In some embodiments, prior to determining an improvement potential score, the entity contribution scoring circuitry identifies one or more candidate alternative configuration instruments which share a configuration instrument type with the particular configuration instrument. In particular, a per-configuration instrument score may be determined for each candidate alternative configuration instrument as described above in operation 306. Then an improvement score may be determined for each candidate alternative configuration instrument based on the a per-configuration instrument score and the current configuration instrument per-configuration instrument score. In some embodiments, the improvement score is determined by the difference between the per-configuration score for the candidate alternative configuration instrument and the per-configuration score for the current configuration instrument.

For example, within the financial payment configuration instrument type, a paper check product configuration instrument may have an impact score of −0.5, an ACH debit configuration instrument may have an impact score of 0.8, and an electronic check product configuration instrument may have an impact score of 0.7. An entity may be associated with 5 electronic check product configuration instruments, and thus ACH debit configuration instruments and paper check product configuration instruments may be identified as candidate alternative configuration instruments. Thus, a current per-configuration instrument score may be determined to be 3.5 and per-configuration instrument scores of −2.5 and 4 may be determined for the paper check product candidate alternative configuration instrument and ACH debit candidate alternative configuration instrument, respectively. As such, an improvement score of −6 may be determined for the paper check product candidate alternative configuration instrument and an improvement score of 0.5 may be determined for the ACH debit candidate alternative configuration instrument.

As shown by operation 408, the apparatus 200 includes means, such as processor 202, memory 204, communications hardware 206, entity contribution scoring circuitry 208, or the like, for identifying one or more alternative configuration instruments. The entity contribution scoring circuitry 208 may identify the one or more alternative configuration instruments based on a corresponding improvement potential score for each candidate alternative configuration instrument. In particular, only candidate alternative configuration instrument associated with a positive improvement potential score may be identified as alternative configuration instruments. As such, only configuration instruments that improve the per-entity contribution score may be identified and subsequently recommended. In some embodiments, only n candidate alternative configuration instruments associated with the highest improvement potential scores are identified as alternative configuration instruments. The value of n may be configured by one or more users, such as entity administrators.

Returning now to FIG. 3, as shown by operation 308, the apparatus 200 includes means, such as processor 202, memory 204, communications hardware 206, entity contribution scoring circuitry 208, or the like, for generating an entity contribution score report. In some embodiments, the entity contribution score report is indicative of the entity contribution score for the entity, as generated in operation 306. In some embodiments, the entity contribution score report may also be indicative of one or more alternative configuration instruments. The entity contribution score report may be provided to one or more computing devices such that end users, such as administrators of the entity, may view the entity contribution score report.

In some embodiments, the entity contribution score report may indicate the entity contribution score relative to the best possible entity contribution score and worst possible entity contribution score. The best entity contribution score and worst entity contribution score may be determined by taking the best and worst impact scores, respectively, for each configuration instrument type of the identified configuration instruments and calculating an entity contribution score as described above. By way of continuing example, an entity may be identified as having 10 paper check product configuration instruments and 5 electronic check product configuration instruments, which may each correspond to a financial payment configuration instrument type. Within the financial payment configuration instrument type, a paper check product configuration instrument may have an impact score of −0.5, an ACH debit configuration instrument may have an impact score of 0.8, and an electronic check product configuration instrument may have an impact score of 0.7. As such, the best entity contribution score may be determined using the ACH debit configuration instrument for all 15 configuration instruments to determine a best entity contribution score of 12. The worst entity contribution score may be determined using the paper check product configuration instrument for all 15 configuration instruments to determine a worst entity contribution score of −7.5.

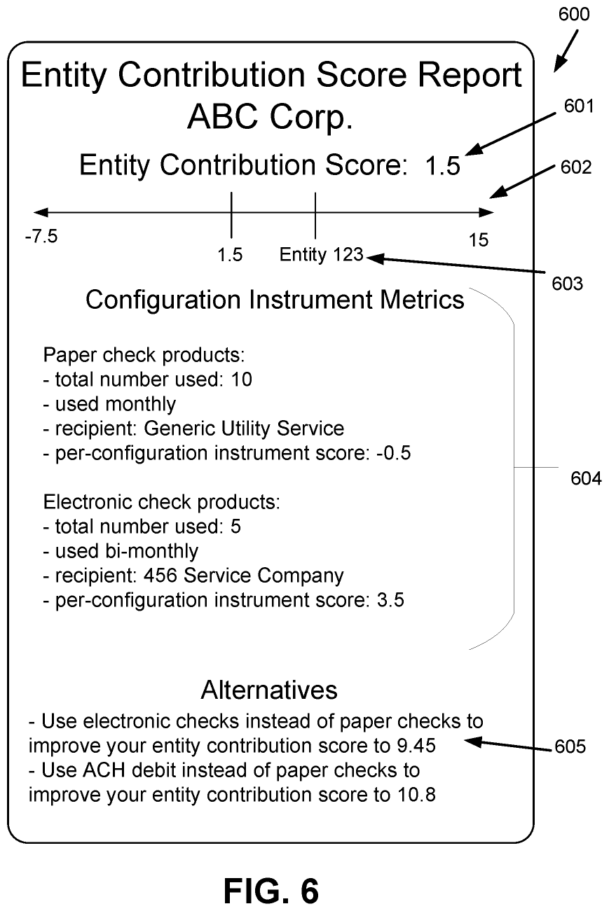

FIG. 6 depicts an operational example of an entity contribution score report 600. The entity contribution score report 600 describes the entity contribution score 601 as determined using the above described operations. In some embodiments, the entity contribution score 601 may depict a graphical rendering 602 depicting the entity contribution score in reference to the worst entity contribution score and best entity contribution score. In some embodiments, the entity contribution score report 600 may describe other entities entity contribution score 603, to the extent the information is available. Additionally, the entity contribution score report 600 may also include the configuration instrument metrics 604 as determined above. The configuration instrument metrics may also include determined attributes for the configuration instruments as well as the per-configuration instrument score each identified configuration instrument. Furthermore, the entity contribution score report 600 may include a recommendation for one or more alternative configuration instruments 605, which may describe alternative configuration instruments to replace currently used configuration instruments. The alternative configuration instruments may also describe the impact on the entity's entity contribution score for each alternative configuration instrument.

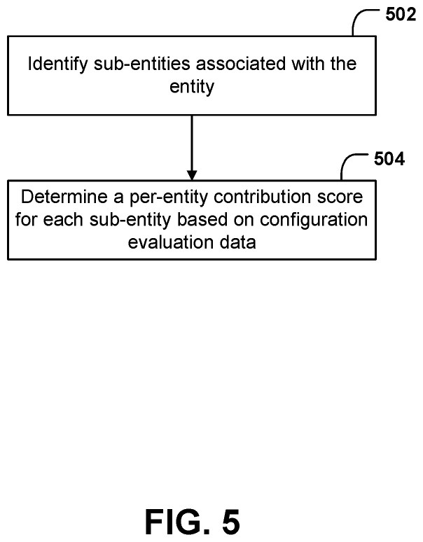

Turning next to FIG. 5, example operations are shown for identifying and providing sub-entity contribution scores for sub-entities. In some embodiments, entities may want a more granular perspective of its individual components to gauge the contribution of each component on its overall entity contribution score. As such, entities may wish to determine a sub-entity score for each associated sub-entity.

As shown by operation 502, the apparatus 200 includes means, such as processor 202, memory 204, communications hardware 206, entity identification circuitry 210, or the like, for identifying one or more sub-entities associated with the entity. In some embodiments, the entity identification circuitry 210 may identify the sub-entities within an entity. For example, an entity with many departments may desire individual sub-entity scores to evaluate each department individually in addition to an overall entity contribution score. The entity identification circuitry 210 may be configured with directory or other data structure indicative of one or more sub-entities which are associated with the entity. For example, an entity may be a large corporation which includes many departments, which may each be identified as a sub-entity. As another example, a particular department may be the entity and individual employees may be identified as sub-entities.

The entity identification circuitry 210 may identify and sort relevant entity configuration evaluation data by based on the corresponding identified sub-entity associated with the configuration evaluation data. In some embodiments, the entity identification circuitry 210 may identify the corresponding sub-entity based on matching keywords identified in configuration evaluation data. Keywords may include the names of employees associated with a particular sub-entity, sub-entity identification numbers, sub-entity email addresses, and/or the like.

Finally, as shown by operation 504, the apparatus 200 includes means, such as processor 202, memory 204, entity contribution scoring circuitry 208, entity identification circuitry 210, configuration identification circuitry 212, or the like, for determining a per-entity contribution score for each sub-entity based on their respective configuration evaluation data. In some embodiments, the entity contribution scoring circuitry may provide per-entity contribution scores for the sub-entities. The per-entity contribution score may be determined by entity contribution scoring circuitry 208 as described above in operations 304-306. The entity contribution score report may also include each per-entity contribution score as determined in operation 504.

As described above, example embodiments provide methods and apparatuses that enable an improved ability for entities to ascertain their external impact through an entity contribution score acquired through analysis of configuration instrument metrics. Further, a system in accordance with embodiment disclosed herein may empower an entity to act upon recommendations to alternative instruments with a productive plan to meet their individual goals. Example embodiments thus provide tools that overcome the problems faced by entities lack of access to data. For example, entities may be empowered to manage their respective levels of impacts through an entity contribution score.

Moreover, embodiments described herein avoid recommendations for alternative instruments without a feasible plan to enact such change. For example, by providing a dynamic threshold for alternative instruments, an entity may enact small changes over a period time to reach the overall goal of acquiring a particular entity contribution score goal.

FIGS. 3, 4, and 5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for generating an entity contribution score for an entity, the method comprising:
retrieving, by communications hardware, a set of entity configuration evaluation data from a first storage device associated with the entity;
identifying, by configuration identification circuitry and based on the set of entity configuration evaluation data, (i) one or more configuration instruments from a plurality of candidate configuration instruments and (ii) for each of the one or more configuration instruments, one or more corresponding configuration instrument metrics;
identifying, by the configuration identification circuitry, one or more corresponding impact scores for each of the one or more configuration instruments;
determining, by entity contribution scoring circuitry and using an entity contribution machine learning model, the entity contribution score for the entity based on the one or more configuration instrument metrics and the one or more corresponding impact scores, wherein the entity contribution machine learning model is configured to weight the impact score based on trained weights for the one or more configuration instruments;
identifying, by the entity contribution scoring circuitry, an alternative configuration instrument for one or more of the one or more configuration instruments from a second storage device that is not associated with the entity; and
generating, by the entity contribution scoring circuitry, an entity contribution score report based on the entity contribution score, wherein the entity contribution score report is indicative of the entity contribution score for the entity and the alternative configuration instrument.

2. The method of claim 1, the method further comprising:
determining, by the entity contribution scoring circuitry and using the entity contribution machine learning model, a per-configuration instrument score for each configuration instrument of the one or more configuration instruments, wherein the per-configuration instrument score for a particular configuration instrument is determined based on the one or more corresponding configuration instrument metrics for the particular configuration instrument, and
determining, by the entity contribution scoring circuitry and using the entity contribution machine learning model, the entity contribution score based on each per-configuration instrument score.

3. The method of claim 2, wherein the entity contribution score report is further indicative of each per-configuration instrument score.

4. The method of claim 2, the method further comprising:
determining, by the entity contribution scoring circuitry, whether a particular per-configuration instrument score fails to satisfy one or more per-configuration instrument score thresholds, wherein the one or more alternative configuration instruments are identified in an instance in which the particular per-configuration instrument score associated with a particular configuration instrument fails to satisfy the one or more per-configuration instrument score thresholds.

5. The method of claim 4, the method further comprising:
identifying, by the entity contribution scoring circuitry, one or more candidate alternative configuration instruments sharing a configuration instrument type with the particular configuration instrument;
determining, by the entity contribution scoring circuitry, an improvement potential score for each of the one or more candidate alternative configuration instruments, wherein each improvement potential score is determined based on (i) the per-configuration instrument score for the particular configuration instrument and (ii) a per-alternative configuration instrument score for a candidate alternative configuration instrument; and
identifying, by the entity contribution scoring circuitry, the one or more alternative configuration instruments based on the improvement potential scores associated with the one or more candidate alternative configuration instruments.

6. (canceled)

7. (canceled)

8. The method of claim 1, further comprising:
identifying, by an entity identification circuitry, one or more sub-entities associated with the entity; and
for each of the identified configuration instruments, determining, by the entity contribution scoring circuitry, a sub-entity contribution score for each identified sub-entity based on the set of entity configuration evaluation data, wherein the entity contribution score report is indicative of each sub-entity contribution score.

9. An apparatus for generating an entity contribution score for an entity, the apparatus comprising:
communications hardware configured to:
retrieve a set of entity configuration evaluation data from a first storage device associated with the entity;
configuration identification circuitry configured to:
identify, based on the set of entity configuration evaluation data, (i) one or more configuration instruments from a plurality of candidate configuration instruments and (ii) for each of the one or more configuration instruments, one or more corresponding configuration instrument metrics,
identify one or more corresponding impact scores for each of the one or more configuration instruments; and
entity contribution scoring circuitry configured to:
determine, using an entity contribution machine learning model, the entity contribution score for the entity based on the one or more configuration instrument metrics and the one or more corresponding impact scores, wherein the entity contribution machine learning model is configured to weight the impact score based on trained weights for the one or more configuration instruments;
identify an alternative configuration instrument for one or more of the one or more configuration instruments from a second storage device that is not associated with the entity, and
generate an entity contribution score report based on the entity contribution score, wherein the entity contribution score report is indicative of the entity contribution score for the entity and the alternative configuration instrument.

10. The apparatus of claim 9, wherein the entity contribution scoring circuitry is further configured to:
determine, using the entity contribution machine learning model, a per-configuration instrument score for each configuration instrument of the one or more configuration instruments, wherein the per-configuration instrument score for a particular configuration instrument is determined based on the one or more corresponding configuration instrument metrics for the particular configuration instrument; and
determine, using the entity contribution machine learning model, the entity contribution score based on each per-configuration instrument score.

11. The apparatus of claim 10, wherein the entity contribution score report is further indicative of each per-configuration instrument score.

12. The apparatus of claim 10, wherein the entity contribution scoring circuitry is further configured to:
determine whether a particular per-configuration instrument score fails to satisfy one or more per-configuration instrument score thresholds, wherein the one or more alternative configuration instruments are identified in an instance in which the particular per-configuration instrument score associated with a particular configuration instrument fails to satisfy the one or more per-configuration instrument score thresholds.

13. The apparatus of claim 12, wherein the entity contribution scoring circuitry is further configured to:
identify one or more candidate alternative configuration instruments sharing a configuration instrument type with the particular configuration instrument;
determine an improvement potential score for each of the one or more candidate alternative configuration instruments, wherein each improvement potential score is determined based on (i) the per-configuration instrument score for the particular configuration instrument and (ii) a per-alternative configuration instrument score for a candidate alternative configuration instrument; and
identify the one or more alternative configuration instruments based on the improvement potential scores associated with the one or more candidate alternative configuration instruments.

14. (canceled)

15. (canceled)

16. The apparatus of claim 9, wherein:
the entity identification circuitry is further configured to identify one or more sub-entities associated with the entity; and
the entity contribution scoring circuitry is further configured to for each of the identified configuration instrument, determine a sub-entity contribution score for each identified sub-entity based on the set of entity configuration evaluation data, wherein the entity contribution score report is indicative of each sub-entity contribution score.

17. A computer program product for generating an entity contribution score for an entity, the computer program product comprising at least one non-transitory computer-readable storage medium storing computer-executable instructions that, when executed, cause an apparatus to:
retrieve a set of entity configuration evaluation data from a first storage device associated with the entity;
identify, based on the set of entity configuration evaluation data, (i) one or more configuration instruments from a plurality of candidate configuration instruments and (ii) for each of the one or more configuration instruments, one or more corresponding configuration instrument metrics;
identify one or more corresponding impact scores for each of the one or more configuration instruments;
determine, using an entity contribution machine learning model, the entity contribution score for the entity based on the one or more configuration instrument metrics and the one or more corresponding impact scores, wherein the entity contribution machine learning model is configured to weight the impact score based on trained weights for the one or more configuration instruments;
identify an alternative configuration instrument for one or more of the one or more configuration instruments from a second storage device that is not associated with the entity; and
generate an entity contribution score report based on the entity contribution score, wherein the entity contribution score report is indicative of the entity contribution score for the entity and the alternative configuration instrument.

18. The computer program product according to claim 17, wherein the at least one non-transitory computer-readable storage medium storing the computer-executable instructions that, when executed, further cause the apparatus to:
determine, using the entity contribution machine learning model, the entity contribution score for the entity further comprises determining a per-configuration instrument score for each configuration instrument of the one or more configuration instruments, wherein the per-configuration instrument score for a particular configuration instrument is determined based on the one or more corresponding configuration instrument metrics for the particular configuration instrument, and
determine, using the entity contribution machine learning model, the entity contribution score based on each per-configuration instrument score for each identified configuration instrument.

19. The computer program product according to claim 17, wherein the entity contribution score report is further indicative of each per-configuration instrument score.

20. The computer program product according to claim 17, wherein the at least one non-transitory computer-readable storage medium storing the computer-executable instructions that, when executed, further cause the apparatus to:
determine whether a particular per-configuration instrument score fails to satisfy one or more per-configuration instrument score thresholds, wherein the one or more alternative configuration instruments are identified in an instance in which the particular per-configuration instrument score associated with a particular configuration instrument fails to satisfy the one or more per-configuration instrument score thresholds.

21. The computer program product according to claim 20, wherein the at least one non-transitory computer-readable storage medium storing the computer-executable instructions that, when executed, further cause the apparatus to:
identify one or more candidate alternative configuration instruments sharing a configuration instrument type with the particular configuration instrument;
determine an improvement potential score for each of the one or more candidate alternative configuration instruments, wherein each improvement potential score is determined based on (i) the per-configuration instrument score for the particular configuration instrument and (ii) a per-alternative configuration instrument score for a candidate alternative configuration instrument; and
identify the one or more alternative configuration instruments based on the improvement potential scores associated with the one or more candidate alternative configuration instruments.

22. The computer program product according to claim 17, wherein the at least one non-transitory computer-readable storage medium storing the computer-executable instructions that, when executed, further cause the apparatus to:
identify one or more sub-entities associated with the entity; and
for each of the identified configuration instruments, determine a sub-entity contribution score for each identified sub-entity based on the set of entity configuration evaluation data, wherein the entity contribution score report is indicative of each sub-entity contribution score.

23. The method of claim 1, wherein the impact score is a numerical value indicative of a level of impact a particular configuration instrument has on external conditions.

24. The apparatus of claim 9, wherein the impact score is a numerical value indicative of a level of impact a particular configuration instrument has on external conditions.
